(19) United States
(12) Patent Application Publication
(10) Pub. No.: US 2004/0062594 A1
(43) Pub. Date: Apr. 1, 2004

(54) Connection group for movable road barriers

(75) Inventor: Alessio Dainelli, San Gimignano (IT)

Correspondence Address: STEINBERG & RASKIN, P.C., 1140 AVENUE OF THE AMERICAS, 15th FLOOR, NEW YORK, NY, 10036-5803, US

(73) Assignee: Findeco S.r.L.

(21) Appl. No.: 10/658,156

(22) Filed: Sep. 8, 2003

(30) Foreign Application Priority Data
Sep. 9, 2002 (IT) FI2002A000165

(51) Int. Cl. F16B 7/10

(52) U.S. Cl. 403/52

(57) ABSTRACT

A connection group for movable road barriers, comprising a pair of jawed joints (3, 4) suitable for being attached to the respective upright members (1, 2) of adjacent barriers and connected to each other in such a way as to compensate imperfections as regards the coplanarity and/or the parallelism of said upright members due to the conformation of the ground on which the barriers are set up.

### FIELD OF THE INVENTION

The present invention relates to a connection group for movable road barriers.

### DESCRIPTION OF THE TECHNICAL FIELD

It is a common practice to delimit or surround such public places as squares, roads or special areas by means of movable barriers or hurdles to prevent access, regulate traffic or perform similar functions. The barriers, usually made of metal, generally have a structure consisting of a base from which there extend two lateral upright members supporting a panel, which may have various shapes and dimensions, bearing inscriptions and/or two-coloured diagonal bands.

When an area is to be fenced off, the barriers are placed in line, each adjacent to the next, and joined together with the help of connecting means consisting, as a general rule, of a pair of substantially square hooks that extend in the plane of the barrier from one of the two lateral uprights for engaging with corresponding tubular appendices projecting from the other lateral upright of the adjacent barrier.

When the ground on which the barrier bases are placed is irregular, however, it is very often difficult or even impossible to connect the barriers to each other. Indeed, the condition that makes it possible to effect the connection is that the adjacent upright members of the barriers to be connected should be substantially coplanar and parallel. If, for example, the two barriers are not coplanar or if their adjacent uprights tend to converge, this will negatively affect the possibility of getting the hooks to engage with their respective tubular appendices and, as a general rule, continuity of the barrier line is assured by resorting to improvised solutions for connecting the individual barrier elements or tolerating their being in precarious equilibrium and in incomplete contact with the ground. It should further be noted that the barrier connection systems that have so far been employed do not provide for locking the connection, and it is therefore possible for the barriers to be readily separated even by unauthorized persons.

### OBJECTS AND SUMMARY OF THE INVENTION

It is an object of the present invention to provide a connection group for connecting movable road barriers that will make it possible to create barrier lines even on moderately irregular ground on which it is not possible to maintain the necessary parallelism of their lateral uprights if the barriers are also to rest firmly and stably on the ground.

Another object of the present invention is to provide a connection group for connecting movable road barriers that will make it possible to lock the connection after it has been made, thereby preventing any unauthorized opening of the barrier line.

These aims are attained by means of the connection group for connecting road barriers in accordance with the present invention, which has the feature of comprising a pair of jawed joints that can be attached to the respective uprights of two adjacent barriers and connected to each other in an articulated manner in order to compensate a possible lack of coplanarity and/or parallelism of the uprights due to the conformation of the ground on which the barriers are erected. In particular, the connection between the two joints is made by means of an elastic articulation, preferably consisting of a helical spring that has its respective ends connected to said joints.

### BRIEF DESCRIPTION OF THE DRAWINGS

The characteristics and advantages of the connection group for connecting movable road barriers in accordance with the present invention will be brought out more clearly by the following description of a particular embodiment thereof, which is given by way of example and is not to be considered limitative in any way, the description making reference to the attached drawings, of which:

FIG. 1 shows a perspective view of a connection group for connecting movable road barriers in accordance with the invention;

FIG. 2 shows a side elevation of the connection group of FIG. 1;

FIG. 3 shows a longitudinal section of the connection group taken along lines III-III of FIG. 2,

FIG. 4 shows an enlarged view of a detail of FIG. 3;

FIG. 5 shows a cross section of the connection group taken along lines V-V of FIG. 2.

### DETAILED DESCRIPTION OF THE INVENTION

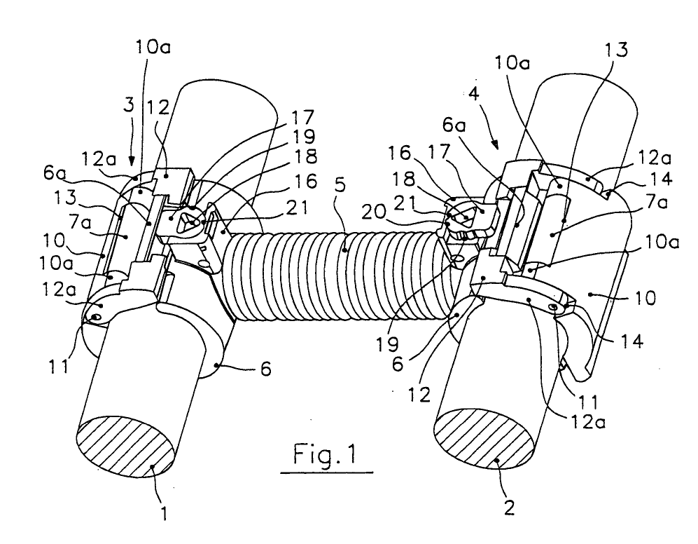

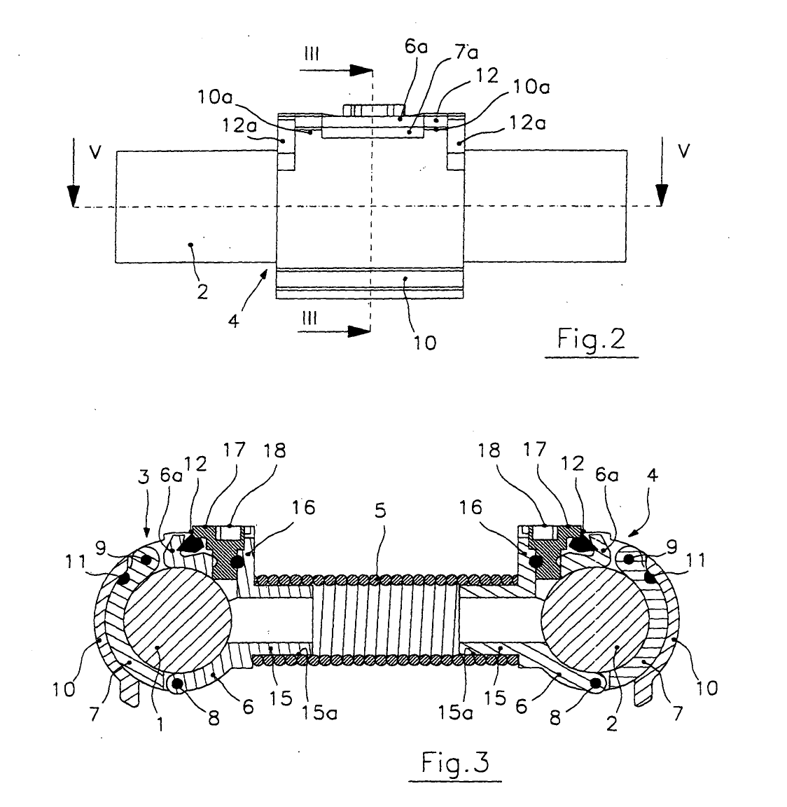

With reference to the drawings and in particular to FIG. 1, the reference numbers 1 and 2 indicate, respectively, the two upright members of two conventional movable road barriers, not completely shown, arranged in line and next to each other. The reference numbers 3 and 4 are used to generically indicate a pair of identically shaped joints of the jawed type connected to each other by means of a helicoidal spring 5 that has its respective ends connected to the joints 3 and 4.

Being of the same shape, joints 3 and 4 are characterized by the same components, which in the drawings will be indicated by means of the same reference numbers.

Each of the joints 3 and 4 consists of an inner jaw 6 and an outer jaw 7 pivotably connected to each other at their respective ends by means of a pin 8. Both the inner jaw 6 and outer jaw 7 has a semi-annular profile with a semi-circular internal section, but it is quite obvious that the internal section could be of any shape whatsoever, always provided that it matches the shape of uprights 1 and 2. Outer jaw 7 has its other end pivotably connected by means of a pin 9 to an operating lever 10 that, in its turn, is pivotably connected by means of a pin 11 to two arms 12a of a crosspiece 12. Pin 11 that connects the operating lever 10 to the crosspiece 12 extends transversely at a position intermediate between pin 9, which connects outer jaw 7 to operating lever 10, and the free end of said operating lever 10.

Transversely and in a position intermediate between pin 9 that connects outer jaw 7 to the operating lever, the operating lever 10 extends above outer jaw 7 and is provided with a pair of arms 10a defining a recess for arranging the end 7a of outer jaw 7. End 7a, in its turn, is provided with a seating, not shown, for pin 9. Operating lever 10 is also provided with two identical recesses 14 in which there are accommodated arms 12a of crosspiece 12.

The end of inner jaw 6 opposite the end that is articulated to outer jaw 7 has a substantially hook-shaped appendix 6a, open at its upper side, with which a correspondingly shaped portion of crosspiece 12 can engage to close joint 3 (or 4).

Spring 5 is connected to joints 3 and 4 by virtue of the fact that its terminal coils are wound around respective sleeves 15 that extend radially from inner jaws 6. With a view to assuring a more stable connection between the coils of spring 5 and sleeves 15, the lateral surface of the sleeves is provided with a helicoidal groove 15a (which can be seen in FIGS. 3 and 5) acting as a seating for the coils of spring 5.

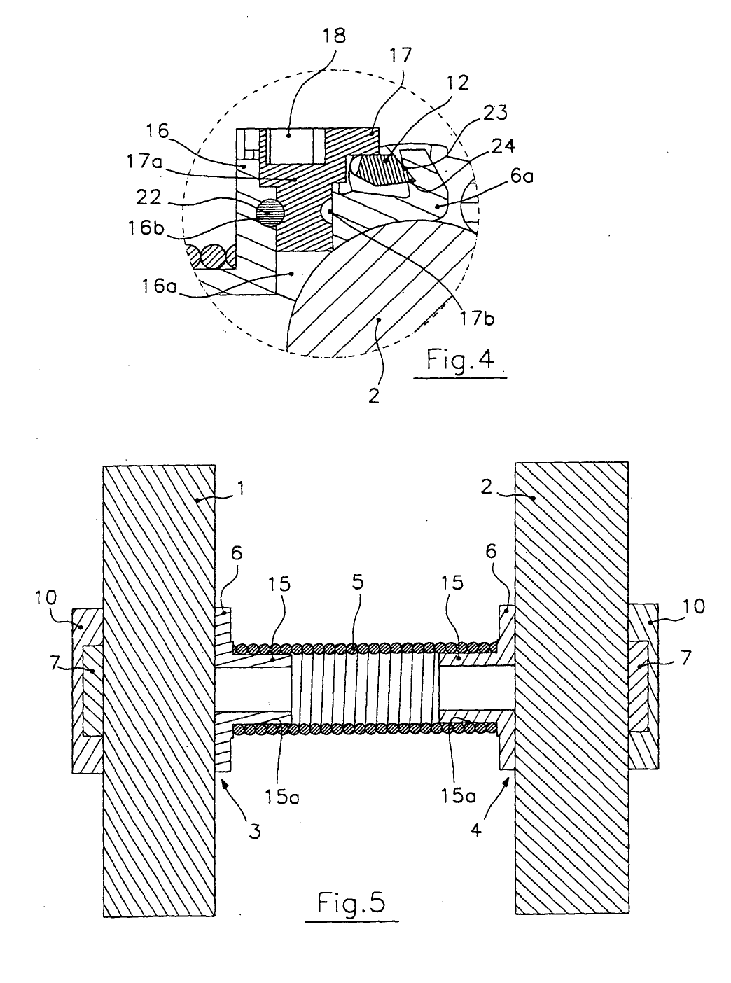

In order to permit joint 3 (or 4) being locked in the closed position shown in the figures, inner jaw 6 is provided with a small turret 16 extending at right angles to the respective sleeve 15 on the same side as the hook-shaped appendix 6a. Referring now to FIG. 4, within the turret there is provided a seating 16a that engages with stem 17a of a lock bolt 17 that, on being rotated about its own axis, can be made to abut against crosspiece 12 when it is engaged in the hook-shaped appendix, thus preventing the crosspiece from becoming disengaged and therefore the opening of the joint. With a view to permitting lock bolt 17 to be rotated, it is provided with a cavity 18 along the axis of its stem 17a. Cavity 18 is appropriately shaped to enable it to accommodate a correspondingly shaped key tool by means of which lock bolt 17 can be rotated. With a view to making it possible for lock bolt 17 to be locked in the closed positions, as also in the open position, which is reached by turning it through 90°, on the side of the lock bolt 17 there are provided in corresponding position two side grooves 19 and 20, angularly spaced by 90°, in which a tooth 21 provided on turret 16 can be engaged. In order to release and rotate the lock bolt, it will therefore be necessary to overcome the resistance of the connection between tooth 21 and grooves 19 or 20.

In order to make it possible for stem 17a of lock bolt 17 to be locked in seating 16a of turret 16, there is provided a pin 22 arranged in a transverse groove 16b of turret 16 and projecting into a corresponding annular groove 17b of stem 17a.

As shown by the detail of FIG. 4, crosspiece 12 can be advantageously provided with a wedge-shaped corner 23 that, in the closed condition of the joint, comes to engage with a corresponding recess 24 provided on inner face of the hook-shaped appendix 6a. In this way crosspiece 12 abuts at one side against recess 24 and on the other side against lock bolt 17 that exerts a moderate force on it. Crosspiece 12 is therefore locked against hook-shaped appendix 6a without any clearance whatsoever, thus assuring the perfect stability of the connection between the joint and the relevant upright.

The connection group in accordance with the present invention can also be advantageously employed to provide a transverse stiffening of the barrier line by doubling some of the barrier members with corresponding parallel barriers. In this case, in order to connect the barrier members in parallel, it is possible to use the connection group according to the invention which is made rigid, i.e. no longer articulated, by insertion, within spring 5 and coaxially thereto, of a rigid bar, not shown, the ends of which are engaged within sleeves 15

Variations and/or modifications can be brought to the connection group for connecting movable road barriers in accordance with the present invention without departing from the scope of the invention as set forth in the appended claims.

1. A connection group for movable road barriers, comprising a pair of jawed joints suitable for being attached to the respective upright members of adjacent barriers and connected to each other in such a way as to compensate imperfections as regards the coplanarity and/or the parallelism of said upright members due to the conformation of the ground on which the barriers are set up.

2. The connection group according to claim 1, wherein said joints are connected to each other by means of an elastic joint.

3. The connection group according to claim 2, wherein said elastic joint is a helical spring of which the ends are connected to said joints.

4. The connection group according to claim 3, wherein the ends of said helical spring are wound around respective sleeves extending from said joints.

5. The connection group according to claims 1 or 2, wherein each of said joints comprises an inner jaw and an outer jaw of semi-annular shape pivotably connected by means of two respective ends and a lever member with one free end and the other end pivotably connected to the other end of said outer jaw, said lever member being also pivotably connected at an intermediate part to side arms of a substantially C-shaped crosspiece engageable with a hook-shaped protrusion of said inner jaw when said lever member is superposed to said outer jaw, a key device for locking said crosspiece in the position in which it is engaged with said protrusion being also provided on said inner jaw.

6. The connection group according to claim 5, wherein said key device comprises a rotatable lock bolt in a seating provided on said inner jaw on the same side as said hook-shaped protrusion, said lock bolt being lockable in a closed position in which it abuts against said crosspiece when it is engaged with said hook-shaped protrusion and in an open position angularly spaced by about 90°.

7. The connection group according to claims 5 or 6, wherein said hook-shaped protrusion is provided with a seating for engaging a correspondingly shaped corner of said crosspiece that, at the same time, also abuts against said lock bolt when it is in its closed position.

8. The connection group according to claim 6, wherein said lock bolt is provided with a pair of side seatings, spaced by about 90° with respect to each other, for engaging a corresponding tooth integral with said inner jaw to lock the rotation of the lock bolt in, respectively, its closed and open position.

9. The connection group according to claim 4, wherein a rigid bar can be interposed between said joints, coaxially with said spring, the ends of said rod being connected to said sleeves in order to provide a substantially rigid connection between parallel barriers.
